(19) United States
(12) Patent Application Publication
(10) Pub. No.: US 2003/0075666 A1
(43) Pub. Date: Apr. 24, 2003

(54) Plate or bowl anchor

(76) Inventors: Richard Stephen Dunchock, Laguna Beach, CA (US); Ta-Hsun Chien, Hsin-Tien City (TW); Pei-Hsiu Huang, Sanchung City (TW)

Correspondence Address: Mr. Meng-Tsuey, Pan, P. O. Box 1-252, Sanchung City, TW

(21) Appl. No.: 10/270,836

(22) Filed: Oct. 10, 2002

(30) Foreign Application Priority Data
Oct. 19, 2001 (TW) 090217880

(51) Int. Cl. F16M 11/00

(52) U.S. Cl. 248/682

(57) ABSTRACT

The invention is related to a plate or bowl anchor which comprises a plate body or bowl body and a positioning device at the bottom thereof, wherein the said positioning device includes a positioning board, a mounting frame and a fixing mount for positioning board. It is characterized in multiple methods of installation as described below: a thread-installing type of plate or bowl anchor is composed of a threaded indentation molded at the bottom of said plate body or bowl body and a corresponding threaded ring provided on the fixing mount for positioning board of said positioning device, which is connected with the plate body or bowl body by screwing the above threaded indentation and the threaded ring together; a pivotal-installing type of plate or bowl anchor consists of a dovetail-like groove set on the back of said plate body or bowl body and a corresponding dovetail disposed on the fixing mount for positioning board by means of installing the dovetail with the dovetail-like groove; an inserting type of plate or bowl anchor includes a flat T-shaped groove set at the bottom of said plate body or bowl body and a corresponding flat T-shaped tenon formed on the fixing mount for positioning board by inserting the above tenon into the flat T-shaped groove; a fastening type of plate or bowl anchor contains one hook fastening tape set on the rear of said plate body or bowl body and another loop fastening tape situated on the fixing mount for positioning board by fitting the said hook and loop fastening tapes together; finally, a plurality of arcked containment edges are set at the bottom of plate body or bowl body and the fixing mount for positioning board has disposed several corresponding arcked projecting rims for interlocking with the arcked containment edges to constitute a locking type of plate or bowl anchor. It is easy to assemble each of the above examples of present invention for use and to dismantle the invention in a short time alter utilization.

### BACKGROUND OF THE INVENTION

1) Field of the Invention

The present invention is related to a plate or bowl anchor and particularly to a positioning device connected with the plate or bowl anchor of which the installation and use are much more convenient than ever before.

2) Description of the Prior Art

A conventional bowl anchor 3a or plate anchor, as shown in FIG. 9, is comprised of a bowl body 30 or plate body that has installed at the bottom a projecting ring 31 with a grooved ring 32 thereon and a sucker 4a that has formed a reverse L-shaped containment edge 41 which is locked into the said grooved ring 32 on the projecting ring 31. The sucker 4a at the bottom of the bowl body 30 of the bowl anchor 3a (or plate anchor) is fixed on a table or flat surfaces for use; however, air leakage or seepage will occur from the joint between the grooved ring 32 and the reverse L-shaped containment edge 41, thereby preventing it from attaching to a table in a sustained condition of adhesion, which is a great inconvenience for users such as disabled, sick people or children.

Although some dealer attempted to find a solution to the problem of air leakage and weak adhesion, another bowl anchor 3b or plate anchor, as illustrated in FIG. 10, still contains two drawbacks. The conventional bowl anchor 3b or plate anchor has disposed at the bottom a projecting ring 31 which is directly inserted into a grooved ring 42 on a sucker 4b, so its lack of well-designed structure for fastening results in a circumstance that the bowl body 30 has easily come off the sucker 4b fixed on a table or flat surfaces. Besides the foregoing shortcoming, when the sucker 4b is attached to a table or flat surfaces, the sucker 4b may bounce or turn into an upward state due to the “elastic stress” of sucker body 40 and such elastic stress causes sucker to fall off from the table. Therefore, the conventional bowl anchor 3b or plate anchor is not firmly adhered to the table or flat surfaces and unable to remain tightly adhesive in a sustained condition of adhesion.

Recently, there is one improvement on the plate body having installed at the bottom three columns; each column is fastened with a small sucker on its lower side to constitute a plate anchor (with no such drawing attached.) Compared with the suckers 4a and 4b, the small sucker of plate anchor is capable of affixing onto a table for a longer period because such small sucker carries less elastic stress; however, it is not convenient for users to press three small suckers to fix them on a table and then after utilization they are disconnected from the table one by one. It is especially inconvenient to wash or carry the plate anchor or to store it in a cupboard after utilization since the columns with small suckers permanently installed at the bottom of plate anchor can not be disassembled.

The applicant of the invention herein, Mr. Huang, once made an invention about a positioning device (Taiwan Utility Model No. 161711) and applied it to manufacture products such as beverage holders and pen holders, which are capable of attaching onto a table or flat surfaces in a sustained state of adhesion. It is unlikely to remove or push them away from the table so no wobbling and toppling may occur, resulting in good comments on providing much convenience to users. Afterwards, Mr. Huang and his two friends noticed the deficiency and inconvenience of conventional plate or bowl anchor; they discussed together how to improve the positioning device and then conducted research and testing that culminated in the innovative development of the invention herein.

### SUMMARY OF THE INVENTION

The objective of the invention herein is to provide a plate or bowl anchor or other similar dietetic utensils or dining wares which are disposed a positioning device at the bottom thereof. It is easy to assemble the present invention for use and to dismantle in a short time to clean, carry or store in a cabinet after utilization. It is also capable of adhering to a table in a sustained condition of adhesion, thereby precluding the possibility of wobbling or displacement and preventing from overturning the plate or bowl anchor or other similar wares during utilization.

The brief description of the drawings below is followed by the detailed description of the invention.

### BRIEF DESCRIPTION OF THE DRAWINGS

FIG. 1 is the first example of plate anchor of the present invention, as viewed from the top.

FIG. 2 is a vertical sectional drawing of the present invention to illustrate the first example of plate anchor.

FIG. 3 is a breakdown view of positioning device of the invention.

FIG. 4 is a side view and partially vertical sectional drawing of the invention herein to illustrate the second example of plate anchor.

FIG. 5 is a side view and partially vertical sectional drawing of the invention herein to illustrate the third example of plate anchor.

FIG. 6 is a side view and partially vertical sectional drawing of the invention herein to illustrate the fourth example of plate anchor.

FIG. 7 is a side view and partially vertical sectional drawing of the invention herein to illustrate the fifth example of plate anchor.

FIG. 8 is a cross-sectional drawing of FIG. 7 as viewed from the perspective of position 8-8′.

FIG. 9 is a vertical sectional drawing of prior bowl anchor.

FIG. 10 is a vertical sectional drawing of lately conventional bowl anchor.

### DETAILED DESCRIPTION OF THE INVENTION

The present invention can be best described in detail in conjunction with the accompanied drawings as follows:

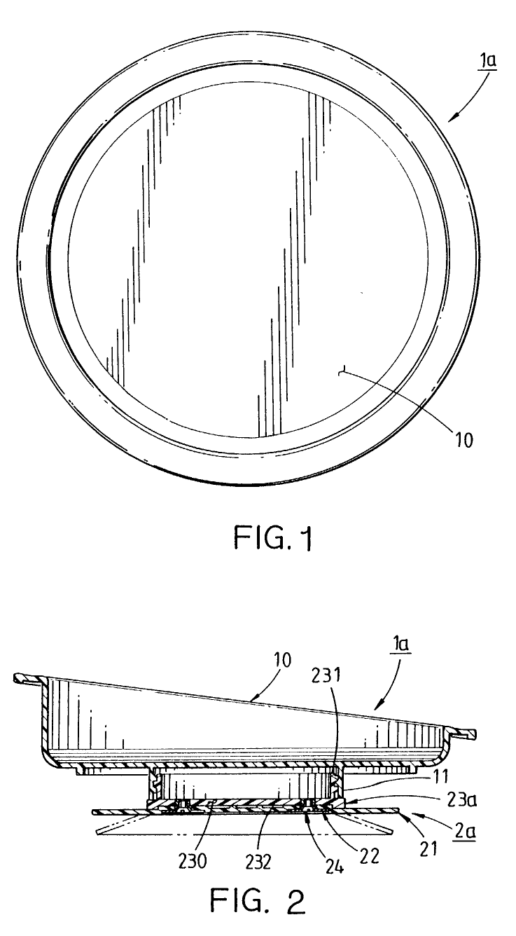

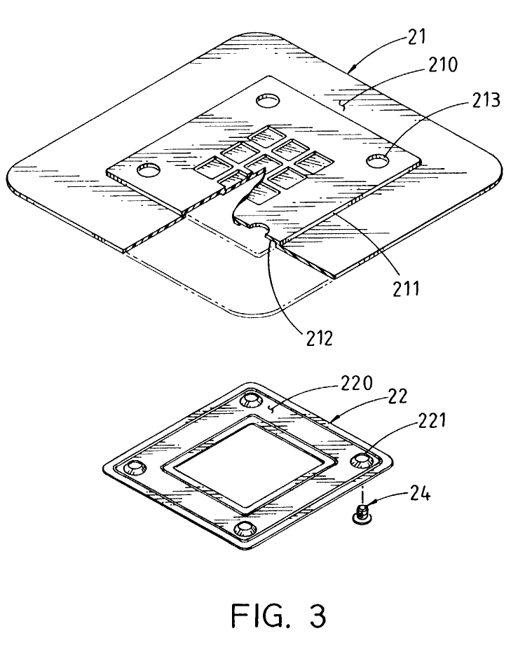

Referring to FIGS. 1 and 2, a first example of plate anchor 1 a or bowl anchor of the present invention is mainly comprised of a plate body 10 or bowl body, wherein the plate body 10 consists of a first type of positioning device 2a at the bottom thereof. The positioning device 2a includes a positioning board 21, a mounting frame 22 and a first fixing mount for positioning board 23a; the plate body 10 is made of nontoxic plastics or melaminc and other similar materials which are suitable to manufacture dietetic utensils and dining wares. A threaded indentation 11 is molded at the bottom of plate body 10 and a corresponding threaded ring 231 is provided on the fixing mount body 230 of fixing mount for positioning board 23a to enable the fastening and conjoinment of threaded ring 231 with the threaded indentation 11. Therefore, the bottom of plate body 10 or bowl body is fastened on the positioning device 2a to constitute the first example of plate anchor 1a or bowl anchor for children, disabled or sick people to have their meal by using the said plate or bowl fixed on a flat surface or table. Turning to FIG. 3, the board body 210 of positioning board 21 is made of semisoft plastic or rubber and it is able to be molded in the form of a rectangle, circle, ellipsoid or other shape; however, it is indispensable to mold a protrudent part 211 on the board body 210 so as to combine with the fixing mount body 230, wherein the board body 210 has formed at the rear a grooved ring 212 or a groove and formed a plurality of holes 213 as well. The mounting frame 22 or mounting board is made by punching a metal sheet, wherein the mounting frame body 220 or mounting board body is corresponding to the grooved ring 212 or groove; moreover, a number of protuberances 221 are installed on the frame body 220 for inserting screws 24 and a recess 232 is set on the fixing mount body 230. After the mounting frame 22 or mounting board is interlocked with the grooved ring 212 or groove at the rear of board body 210, each of the protuberances 221 is pierced by one screw 24 and then the positioning board 21 is fixed in the recess 232 of fixing mount body 230 so that the components of positioning device 2a, as shown in FIG. 2, are put together, thereby being installed at the bottom of plate body 10 or bowl body to constitute the first example of plate anchor 1a or bowl anchor.

Since the positioning board 21 of the present invention is made of semisoft plastic or rubber, when the plate body 10 is held in one's hand, the edge of said positioning board body 210 automatically hangs down (as the suppositional lines illustrated in FIG. 2) so as to form a downward adhering state, like a “sucking-disc” state, which enables to firmly attach onto a table or such flat surfaces. The positioning board 21 is tightly fastened with the first fixing mount for positioning board 23a and thus there is no possibility of air leakage. Furthermore, the board body 210 generates no “elastic stress” so it is unlikely to bounce or turn into an upward state, thereby adhering to a table in a sustained condition of adhesion. Even though someone pulls away the plate body 10 with great strength, it is impossible to move or displace the said plate out of the table, and there is no way of removing or turning over the said plate if somebody unintentionally or slightly knocks against it. However, one can easily takes away the plate anchor 1a from the table by simply using one's finger to lift one side or one corner of board body 210 and the removal is complete.

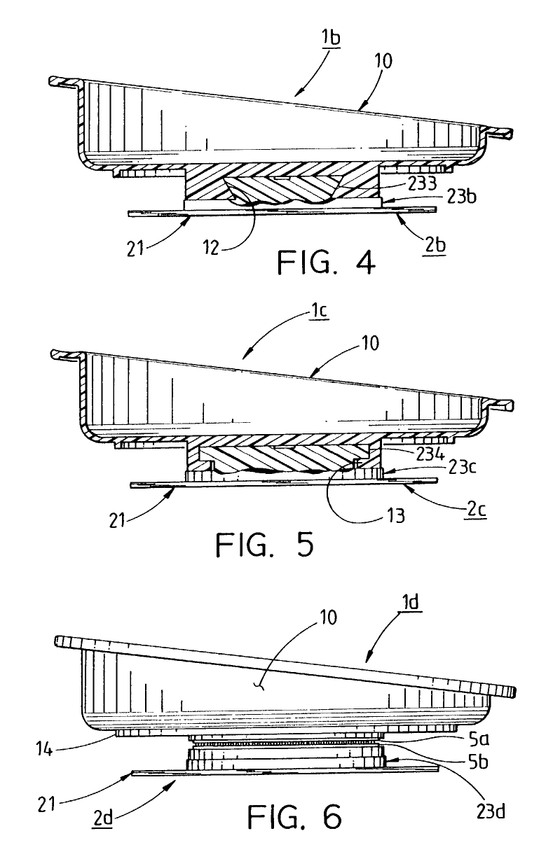

Referring to FIG. 4, a second example of plate anchor 1b or bowl anchor of the present invention is mainly comprised of a plate body 10 or bowl body and a second type of positioning device 2b at the bottom of plate body, wherein the positioning device 2b consists of a positioning board 21, a mounting frame 22 and a second fixing mount for positioning board 23b. A dovetail-like groove 12 is set at the bottom of plate body 10 and disposed on the fixing mount for positioning board 23b is a corresponding dovetail 233 that enables to pivotally install with the dovetail-like groove 12 so that the assemblage of second example of plate anchor 1b or bowl anchor is finished. The positioning board 21 of positioning device 2b is able to adhere onto a table or similar flat surfaces for children, disabled or sick people to have their meal. The usage, features and functions of second example equal as the first plate anchor 1a, hence there is no need to give more details. In addition to the second embodiment of the invention, three different examples of plate or bowl anchor are stated as below.

As indicated in FIG. 5, a third example of plate anchor 1c or bowl anchor of the present invention is mainly comprised of a plate body 10 or bowl body and a third type of positioning device 2c at the bottom of plate body, wherein the positioning device 2c consists of a positioning board 21, a mounting frame 22 and a third fixing mount for positioning board 23c. A flat T-shaped groove 13 is set at the bottom of plate body 10 and the fixing mount for positioning board 23c has formed a corresponding flat T-shaped tenon 234 for interlocking with the flat T-shaped groove 13 to enable the integration of third example of plate anchor 1c or bowl anchor.

Turning to FIG. 6, a fourth example of plate anchor 1d or bowl anchor of the present invention is mainly comprised of a plate body 10 or bowl body and a fourth type of positioning device 2d at the bottom of plate body, wherein the positioning device 2d consists of a positioning board 21, a mounting frame 22 and a fourth fixing mount for positioning board 23d. A hook fastening tape 5a is fastened on a raised surface 14 extended from the bottom of plate body 10; situated on the fixing mount for positioning board 23d is a corresponding loop fastening tape 5b to combine with the said hook fastening tape 5a so that the installation of the fourth example of plate anchor 1d or bowl anchor is complete.

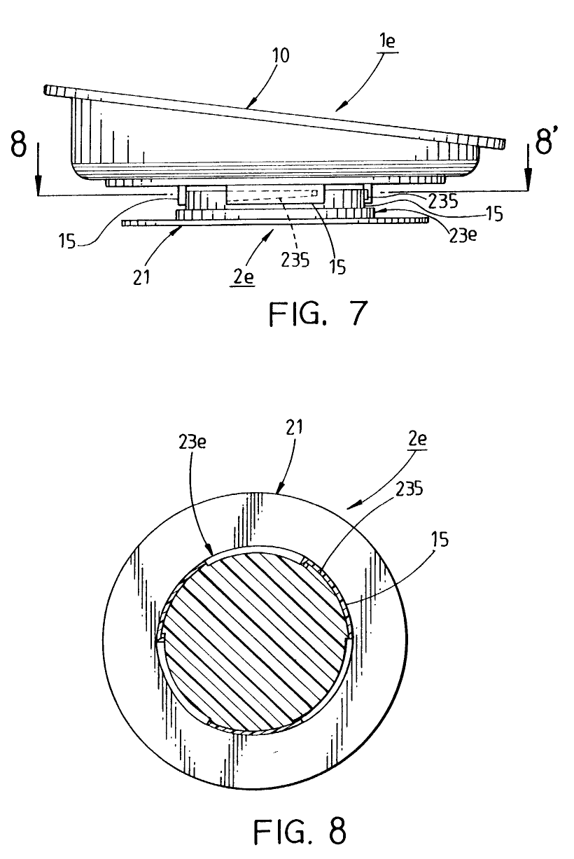

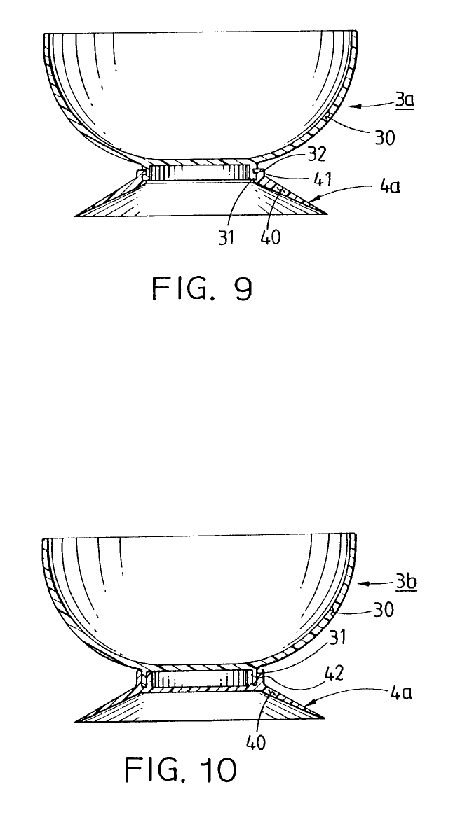

A fifth example of plate anchor 1e or bowl anchor of the present invention, as shown in FIGS. 7 and 8, is composed of a plate body 10 or bowl body and a fifth type of positioning device 2e at the bottom of plate body, wherein the positioning device 2e includes a positioning board 21, a mounting frame 22 and a fifth fixing mount for positioning board 23e. Several arcked containment edges 15 are set at the bottom of plate body 10 and provided on the fixing mount for positioning board 23e are corresponding arcked projecting rims 235 to fit and lock with the arcked containment edges 15 and therefore the assembly of the fifth example of plate anchor 1e or bowl anchor is complete.

In conclusion, each positioning device of the five embodiments of plate or bowl anchor is able to apply in other similar dietetic utensils or dining wares and it is capable of adhering to a table or such flat surfaces in a sustained condition of adhesion; moreover, it is easy to take apart or separate the positioning device from the plate body or bowl body for storage after utilization or cleaning.

1. A plate or bowl anchor or other similar dietetic utensils or dining wares consisting of:
a plate body or bowl body;
a positioning device at the bottom of said plate body or bowl body including:
a positioning board;
a mounting frame;
a fixing mount for positioning board,
wherein the plate or bowl anchor is characterized in the following structures of installation comprising:
a threaded indentation molded at the bottom of said plate body or bowl body and a corresponding threaded ring provided on the fixing mount for positioning board to constitute a thread-installing type of plate or bowl anchor by screwing the said indentation and the threaded ring together;
a dovetail-like groove set on the back of said plate body or bowl body and a corresponding dovetail disposed on the fixing mount for positioning board for pivotally fastening the dovetail with the dovetail-like groove to constitute a pivotal-installing type of plate or bowl anchor;
a flat T-shaped groove set at the bottom of said plate body or bowl body and the fixing mount for positioning board having formed a corresponding flat T-shaped tenon for inserting into the flat T-shaped groove to constitute an inserting type of plate or bowl anchor;
a hook fastening tape fastened on the rear of said plate body or bowl body and a corresponding loop fastening tape situated on the fixing mount for positioning board to constitute a fastening type of plate or bowl anchor by fitting the said hook and loop fastening tapes together; and
a plurality of arcked containment edges set at the bottom of plate body or bowl body and the fixing mount for positioning board having disposed several corresponding arcked projecting rims for interlocking with the arcked containment edges to constitute a locking type of plate or bowl anchor.

2. The plate or bowl anchor of claim 1 wherein the said positioning device further includes:
a recess set on the back of mount body of said fixing mount for positioning board;
a protrudent part and a number of holes disposed on the board body of said positioning board, which is made of semisoft plastic or rubber in the form of a rectangle, circle or ellipsoid;
a grooved ring or a groove formed at the bottom of said protrudent part;
a plurality of protuberances installed on the frame body of said mounting frame, which is corresponding to the grooved ring or groove of said positioning board,
wherein the mounting frame is interlocked with the grooved ring or groove at the rear of said positioning board body, and then each of the protuberances is inserted by one screw so that the positioning board is fixed in the recess of said fixing mount for positioning board, thereby finishing the assemblage of said positioning device.
